(19) United States
(12) Patent Application Publication
(10) Pub. No.: US 2006/0093717 A1
(43) Pub. Date: May 4, 2006

(54) Continuous thermal process for treating a flow comprising coarse food particles, and food particles obtainable with the process according to the invention

(76) Inventors: Jan Coen Akkerman, Wageningen (DE); Jeroen Jacobu Veldkamp, Den Dungen (NL)

Correspondence Address: NIXON & VANDERHYE, PC, 901 NORTH GLEBE ROAD, 11TH FLOOR, ARLINGTON, VA, 22203, US

(21) Appl. No.: 10/545,316

(22) PCT Filed: Feb. 13, 2004
(86) PCT No.: PCT/NL04/00110

§ 371 Date: Aug. 12, 2005

(30) Foreign Application Priority Data
Feb. 14, 2003 (NL) 1022693

(51) Int. Cl. A47J 39/00

(52) U.S. Cl. 426/520

(57) ABSTRACT

The invention relates to a continuous thermal process for treating a flow comprising coarse food particles and a transport fluid, wherein the food particles, moving freely and with a volume percentage of 20-60% based on the total flow, are passed, by means of the transport fluid, into a heat-up section and subsequently through a hold-warm section, wherein in the heat-up section the transport fluid is heated, under turbulent flow, to a temperature T1 of 65-150° C., after which the transport fluid in the hold-warm section is held at a temperature T2, with (T1-T2) being at most 20° C. The invention further relates to food particles obtainable with the process according to the invention.

The invention relates to a continuous thermal process for treating a flow comprising coarse food particles, and food particles obtainable with the process according to the invention.

The thermal treatment of food particles is an important processing step in the food industry for preparing storage-stable products. In the canning industry, by means of a thermal treatment, coarse food particles can be blanched, sterilized and/or pasteurized. The food particles may already be packaged in cans or glass before they are subjected to the thermal treatment. Normally, they are first subjected to a thermal treatment before being packaged in cans or glass, after which a second thermal treatment takes place. Most food products are nowadays heated in a drum, screw or belt blancher, after which they are recooled in a drum, screw or belt cooler. However, the use of such blanchers and coolers involves a few drawbacks. For instance, they are difficult to clean, and a relatively large residence time distribution occurs within the food particles to be treated, resulting in a corresponding distribution in thermal treatment. Furthermore, the blanchers and coolers take up much space on the work floor, consume much water, cause a substantial waste water load, and incidentally cause problems of end product quality. Therefore, there is room for and a need of developing a process for thermally treating coarse food particles, in which use is made of a system that does not have these drawbacks or in any case reduces them strongly. Comparable drawbacks hold for the current sterilization processes in autoclaves or sterilization towers.

Surprisingly, it has now been found that the above-mentioned problems occur to a much lesser extent, or even do not occur at all, if use is made of a continuous process in which coarse food particles, whilst moving freely and with a high volume percentage, are passed through a heat-up section and subsequently a hold-warm section.

Accordingly, the invention relates to a continuous thermal process for treating a flow comprising coarse food particles and a transport fluid, wherein the food particles, moving freely and with a volume percentage of 20-60% based on the total flow, are passed, by means of the transport fluid, into a heat-up section and subsequently are passed through a hold-warm section, wherein in the heat-up section the transport fluid is heated, under turbulent flow, to a temperature T1 of 65-150° C., after which the transport fluid in the hold-warm section is held at a temperature T2, with (T1-T2) being at most 20° C.

The process according to the invention makes it possible to subject delicate food particles to a thermal treatment in a relatively simple manner. In this way, coarse food particles can, for instance, be sterilized, blanched or pasteurized. The continuous system to be utilized is properly cleanable both internally and externally, which is favorable to the food quality. The system is highly appropriate for heat recovery. Furthermore, lixiviation of water soluble components can be reduced strongly, product loss is reduced, and the volume of waste water can be reduced by no less than 30 percent. In addition to these major advantages, the process can be controlled particularly well, no water vapor is released, maintenance is low-cost, the system occupies less space, and the process causes no or minimal odor and heat emission to the surroundings. Another major advantage is the fact that the food particles can now be subjected to the thermal process outside of the package, which makes it possible to use (transparent) plastic packages instead of conventional and less attractive packages such as glass or cans.

During the process according to the invention, in the hold-warm section, the food particles must obtain a predetermined minimum process value (expressed in, for instance, F₀, P₀, C₀) in order that, for instance, sufficient microbiological and/or enzymatic inactivation and/or cooking is effected. It will be clear that the selected process conditions depend on the kind of food particles and the size of the food particles. It is important that in the thermal center of the food particles a minimum required process value be achieved. The size and thermal properties of the food particles will vary in practice, resulting in different process values for food particles of different sizes. Preferably treated according to the process of the invention, therefore, are food particles that are basically of the same size.

In a suitable embodiment, the food particles reside in the heat-up section for a period of 20 seconds to 2 minutes. The heated food particles subsequently resides in the hold-warm section for a period of 20 seconds to 5 minutes.

In a suitable embodiment of the invention, the transport fluid is a low- to medium-viscous fluid. Preferably, the transport fluid is selected from the group of water, aqueous solutions, pour liquid, or an oil such as, for instance, olive oil or sunflower oil. Preferably, the transport fluid comprises water, and more preferably, clean water.

The food particles and transport fluid can be passed through the heat-up section and the hold-warm section using a pump, compressed gas such as, for instance, compressed air, or gravity. Preferably, use is made of a pump. The mixture of food particles and transport fluid can be passed to the pump from, for instance, a supply tank with an operable butterfly valve. Preferably, the mixture is kept in motion within the supply tank, so that no food particles will accumulate in the supply tank. Different types of pumps can be used in the process according to the invention. The power and the design of the pumps must naturally be such that the required volume percentage of the food particles can be maintained.

The temperature of the transport fluid in the hold-warm section depends on the type, the average size of the food particles to be treated and the desired process. In the process according to the invention, the transport fluid is heated in the heat-up section to a temperature T1 of 65-150° C. The process according to the invention can be a blanching process, a sterilization process or a pasteurization process. The food particles are preferably sterilized by carrying out the process with a T1 of 100-130° C. Blanching, by contrast, will typically be carried out with a T1 of 65-110° C., whereas pasteurization will normally be carried out with a T1 of 70-100° C.

In a suitable embodiment, in the hold-warm section, the transport fluid is held at a temperature (T2) which is equal to the heat-up temperature in the heat-up section. In practice, however, it may happen that the temperature T2 is lower than the temperature T1. However, the difference between these two temperatures must not be greater than 20° C. Preferably, the difference between the temperatures T1 and T2 is at most 10° C.

In the process according to the invention, the volume percentage of the food particles is 20-60%, based on the total flow. Preferably, the volume percentage of the food particles is 30-60%, and more preferably 40-60%, based on the total flow. By virtue of the high volume percentage of the food particles and the turbulent flow in the heat-up section that is used in the process according to the invention, large amounts of food products can be treated in a short time. What is furthermore accomplished is that small and large particles are exposed to the thermal treatment for substantially the same period of time, so that the residence time distribution is particularly low, and food particles are prevented from obtaining a higher process value than is necessary, the so-called overprocessing. As a result, there occurs much less thermal degradation of thermolabile components. Also, there occur far fewer chemical reactions such as browning, and the texture of the food products remains better, so that the products become less slack or overdone. An important aspect can be the minimization of shrinkage, or moisture egress. Accordingly, the invention also relates to food particles that are obtainable with the process according to the invention. As has already been indicated above, these food particles exhibit an improved product quality.

The food particles can be passed through a single transport tube from the heat-up section to the hold-warm section. In a suitable embodiment, use is made of a single transport tube through which the food particles are passed into the heat-up section and subsequently into the hold-warm section. Preferably, the transport tube is a tube of constant diameter.

The heat-up section in the process according to the invention can suitably be a heat exchanger, and is preferably a tubular heat exchanger. The tubular heat exchanger can comprise a double tube in which the transport tube is the inner tube and a heat transfer medium flows through the outer tube. Preferably, the heat transfer medium in the outer tube flows in the direction opposite to the transport fluid and the food particles. In another embodiment, the transport tube is the outer tube and a heat transfer medium flows through the inner tube. Preferably, the double tube is a concentric double tube. If desired, the mixture of the transport fluid and the food particles can be passed through two or more heat-up sections before the heated mixture is passed to the hold-warm section. In another embodiment of the process according to the invention, the heat-up section comprises the transport tube around which a heating element is arranged.

The hold-warm section that is used in the process according to the invention can be an insulated part of the transport tube. It may also be an insulated tube of a greater diameter, or a vat.

In a suitable embodiment of the process according to the invention, the mixture of the transport fluid and the food particles is passed from the hold-warm section to a cooling section in which the transport fluid is cooled down. The cooling section can be a heat exchanger, and is preferably a tubular heat exchanger. The tubular heat exchanger can comprise a double tube in which the transport tube is the inner tube and a heat transfer medium flows through the outer tube. Preferably, the heat transfer medium in the outer tube flows in a direction opposite to the transport fluid and the food particles. In another embodiment, the transport tube is the outer tube and a heat transfer medium flows through the inner tube. Preferably, the double tube is a concentric double tube. If desired, the mixture of the transport fluid and the food particles can be passed through two or more cooling sections. In another embodiment of the process according to the invention, the cooling section comprises the transport tube around which a cooling element has been arranged. The food particles obtained from the cooling section can subsequently be separated from the transport fluid, after which separated transport fluid can be recirculated. In a suitable embodiment, the transport fluid is first cleaned, for instance using a membrane section, before it is reused to convey food particles to the heat-up section. The process should be carried out such that the food particles obtained directly from the cooling section have a core temperature that is lower than the boiling temperature of the food particles. It will be clear to one skilled in the art that the temperature and pressure used in the process will depend on the total length of the system to be used, and the choice of the cooling medium and cooling conditions to be employed.

If desired, or necessary, the obtained cooled food particles can be subjected to a washing step. However, when clean water is used as transport fluid, such a washing step is normally not necessary. In such a washing step, released starch is rinsed off the food particles, to prevent turbid pour liquid being visible in glass pots, which gives the product a better look. Preferably, the washing step is carried out with heated water which preferably has a temperature of 40-80° C.

When the heat-up section and the cooling section comprise tubular heat exchangers, the heat capacity of the mixture of the transport fluid and the food particles (A) and the heat capacity of the heat transfer medium in the outer tube are preferably in a ratio of 1/3-3/1 (A/B), and more preferably of 1/1.5-1.5/1 (A/B).

The diameter of the transport tube will depend on the average size of the coarse food particles. In a suitable embodiment, the diameter is less than or equal to 20 cm, preferably less than or equal to 10 cm, and still more preferably less than or equal to 8 cm. Preferably, the diameter of the transport tube is minimally three times the smallest diameter of the food particles to be treated.

In a suitable embodiment of the invention, the heated food particles of the hold-warm section are passed to a second heat-up section, in which the food particles are heated, under turbulent flow, to a temperature T3 of 65-150° C., after which the food particles are passed to a second hold-warm section, in which the food particles are held at temperature T4, with (T3-T4) being at most 20° C. Thus, the treatment in the first heat-up and hold-warm section can be a blanching process that is followed by a sterilization process in the second heat-up and hold-warm section. In such an embodiment, the mixture from the second hold-warm section can be passed to a cooling section.

In the context of the present invention, coarse food particles are food particles which cannot be kept in emulsion or solution. Such food particles are normally speaking solid food particles. The coarse food particles are suspended, float or sink in a stagnant transport fluid. Normally, they have a smallest diameter of at least 2 mm and preferably the smallest diameter is greater than 3 mm. Suitable coarse food particles can be selected from the group consisting of vegetable products, potato products, fruit products, fish products and meat products. Also, the mixture of the transport fluid and the coarse particles can suitably be a stuffed sauce or a stuffed soup. Suitable vegetable products are, for instance, (cut) carrots, (sliced) mushrooms, lentils, spinach, (cut) string beans, peas, broad beans, corn, marrowfat peas, kidney beans, haricot beans, cauliflower florets and broccoli stalks. Suitable potato products are, for instance, potato chips and crisps. Suitable fruit products can comprise whole fruits such as, for instance, strawberries, olives, blackberries, berries, raspberries, grapes, but also cut-up fruit products such as pieces of apple, orange, melon, banana and mango. The meat products can be suitable both for human consumption, for instance snacks or stuffed meat sauces, and for animal consumption, such as, for instance, dog and cat food. Suitable fish products can be, for instance, sardines, shrimps and small pieces of fish, for instance pieces of herring.

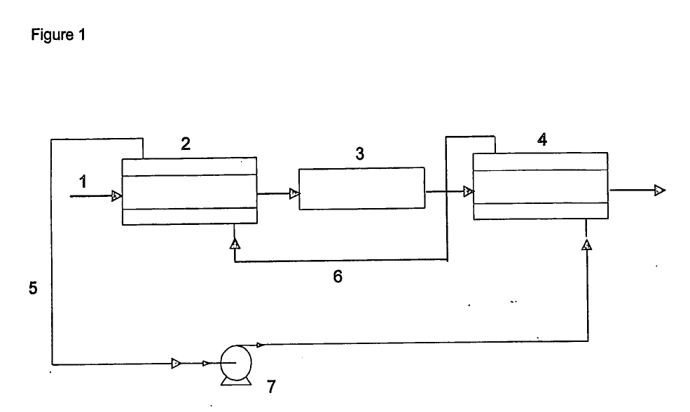

FIG. 1 schematically represents an embodiment of the invention. A mixture of a transport fluid and coarse food particles is passed via a transport tube (1) into the heat-up section (2) in which, under turbulent flow, the transport fluid is heated to a defined desired temperature. The heat-up section is a tubular heat exchanger. The obtained heated mixture is subsequently passed through the transport tube into hold-warm section (3) which comprises the transport tube which is insulated, and in which the transport fluid is held at a particular desired temperature. Next, the mixture is passed through the transport tube from the hold-warm section to cooling section (4) in which the food particles are cooled down. The cooling section is a tubular heat exchanger. Next, the cooled food particles are discharged from the cooling section via the transport tube. A heat transfer medium is recirculated through lines (5) and (6), and pump (7) through the outer tubes of the tubular heat exchangers (2) and (4).

1. A continuous thermal process for treating a flow comprising coarse food particles and a transport fluid, wherein the food particles, moving freely and with a volume percentage of 20-60% based on the total flow, are passed, by means of the transport fluid, into a heat-up section and subsequently are passed through a hold-warm section, wherein in the heat-up section the transport fluid is heated, under turbulent flow, to a temperature T1 of 65-150° C., after which the transport fluid in the hold-warm section is held at a temperature T2, with (T1-T2) being at most 20° C.

2. A continuous thermal process according to claim 1, wherein the food particles reside in the heat-up section for 20 seconds to 2 minutes.

3. A continuous thermal process according to claim 1, wherein the heated food particles reside in the hold-warm section for 20 seconds to 5 minutes.

4. A continuous thermal process according to claim 1, wherein temperature TI is 100-130° C.

5. A continuous thermal process according to claim 1, wherein (T1-T2) is at most 10° C.

6. A continuous thermal process according to claim 1, wherein the volume percentage of the food particles, based on the total flow, is 30-60%.

7. A continuous thermal process according to claim 6, wherein the volume percentage of the food particles, based on the total flow, is 40-60%.

8. A continuous thermal process according to claim 1, wherein the transport fluid comprises water.

9. A continuous thermal process according to claim 1, wherein the food particles are passed through a single transport tube from the heat-up section to the hold-warm section.

10. A continuous thermal process according to claim 9, wherein the transport tube is a concentric tube.

11. A continuous thermal process according to claim 9, wherein the heat-up section comprises a double tube, wherein the inner tube is the transport tube, and a heat transfer medium flows through the outer tube.

12. A continuous thermal process according to claim 1, wherein the transport fluid and the food particles are passed from the hold-warm section to a cooling section in which the transport fluid is cooled down, and wherein the food particles obtained directly from the cooling section have a core temperature that is lower than the boiling point of the food particles.

13. A continuous thermal process according to claim 12, wherein the cooling section comprises a double tube, wherein the inner tube is the transport tube and a heat transfer medium flows through the outer tube.

14. A continuous thermal process according to claim 11, wherein the heat capacity of the mixture of the transport fluid and the food particles (A) and the heat capacity of the heat transfer medium (B) are in a ratio of 1/3-3/1 (A/B).

15. A continuous thermal process according to claim 1, which process is a blanching process, sterilization process or pasteurization process.

16. A continuous thermal process according to claim 15, wherein heated food particles are passed from the hold-warm section to a second heat-up section in which the food particles are heated, under turbulent flow, to a temperature T3 of 65-150° C., after which the food particles are passed to a second hold-warm section in which the food particles are held at temperature T4, with (T3-T4) being at most 20° C.

17. A continuous thermal process according to claim 16, wherein the food particles are passed from the second hold-warm section to a cooling section.

18. A continuous thermal: process according to claim 1, wherein the food particles are solid food particles.

19. A continuous thermal process according to claim 18, wherein the food particles are selected from the group of vegetable products, potato products, fruit products, meat products and fish products.

20. Food particles that are obtainable with the process according to claim 1.
